(19) United States
(12) Patent Application Publication
(10) Pub. No.: US 2016/0063911 A1
(43) Pub. Date: Mar. 3, 2016

(54) Oled Display Device

(71) Applicant: EverDisplay Optronics (Shanghai) Limited, Shanghai (CN)

(72) Inventors: Jeihuang WU, Shanghai (CN); Hsien Hao CHANG, Shanghai (CN); Hung-shun CHEN, Shanghai (CN)

(21) Appl. No.: 14/749,959

(22) Filed: Jun. 25, 2015

(30) Foreign Application Priority Data
Aug. 29, 2014 (CN) 201410432593.9

(51) Int. Cl. G09G 3/20; G09G 3/32

(52) U.S. Cl. CPC G09G 3/2074; G09G 3/3258; G09G 3/3208; G09G 3/3233; G09G 2300/04; G09G 2330/02; G09G 2320/0223; G09G 2320/0233

(57) ABSTRACT

The present application discloses an OLED display device. The OLED display device includes: a plurality of first Sub-pixels displaying a first color; a plurality of second sub-pixels displaying a second color; and a plurality of third sub-pixels displaying a third color. Areas of the third sub-pixels are greater than areas of the first sub-pixels, and are greater than areas of the second sub-pixels. The first sub-pixels and the second sub-pixels are alternately arranged in first columns; the third sub-pixels are arranged in second columns which are adjacent to the first columns; a distance between two third sub-pixels which are immediately adjacent to each other in a second column is a first distance, a distance between a first sub-pixel and a second stab-pixel which are alternately arranged in a first column is a second distance, and the first distance is smaller than the second distance.

### CROSS REFERENCE TO RELATED APPLICATIONS

This application is based upon and claims priority to Chinese Patent Application No. 201410432593.9, filed on Aug. 29, 2014, the entire contents of which are incorporated herein by reference,

### TECHNICAL FIELD OF THE INVENTION

The present disclosure relates to the technical field of display, and more particularly, to an Organic; Light Emitting Diode (OLED) display device.

### BACKGROUND OF THE INVENTION

Compared to liquid crystal display panels in the conventional display technologies, OLED display devices have characteristics such as a faster response purer chromaticity and better brightness, higher ratio of contrast and wider angle of view. Thus, OLED attracts increasing attentions of the developers in the field of display technologies.

In U.S. Pat. No. 8,330,352B2, as OLED display device is disclosed. As shown in FIG. 1, the OLED display device includes red sub-pixels R, green sub-pixels G and blue sub-pixels B which are constituted by a plurality of pixel electrodes 191R, 191G and 191B and a plurality of emitting layers 370R, 370G and 370B. The red sub-pixels R and the green sub-pixels G are arranged in odd columns, the blue sub-pixels B are arranged in even columns, a distance b between any two adjacent blue stab-pixels B is greater than a distance a between a red sub-pixel R and a green sub-pixel G, and each blue sub-pixel B overlaps, in a row direction, with two rows of sub-pixels in odd columns.

### SUMMARY OF THE INVENTION

An object of the present disclosure is to provide an OLED display device to, overcome one or more problems caused by limitations and drawbacks in the related technologies.

According to one aspect of the present disclosure, an OLED display device is provided. The OLEO display device includes; a plurality of first sub-pixels displaying a first color; a plurality of second sub-pixels displaying a second color; and a plurality of third sub-pixels displaying a third color; wherein areas of the third sub-pixels are greater than areas of the first sub-pixels, and are greater than areas of the second sub-pixels; and wherein: the first sub-pixels and the second sub-pixels are alternately arranged in first columns; the third sub-pixels are arranged in second columns which are adjacent to the first columns; a distance between two third sub-pixels which are immediately adjacent to each other in a second column is a first distance, a distance between a first sub-pixel and a second sub-pixel which are alternately arranged in a first column is a second distance, and the first distance is smaller than the second distance.

In an exemplary embodiment of the present disclosure, each of the third sub-pixels only overlaps in a row direction with one row of the sub-pixels in the first columns.

In another exemplary embodiment of the present disclosure, the third sub-pixel has a length greater than a distance between a first sub-pixel and a second sub-pixel which are adjacent to each other.

In another exemplary embodiment of the present disclosure, the first sub-pixels are arranged in first rows, and the second stab-pixels are arranged in second rows which are adjacent to the first rows.

In another exemplary embodiment of the present disclosure, the areas of the first sub-pixels are greater than the areas of the second sub-pixels.

In another exemplary embodiment of the present disclosure, pixel electrodes of two adjacent third sub-pixels, a distance between which is the first distance, are covered by the same light emitting layer.

In another exemplary embodiment of the present disclosure, the first color is a red color, the second color is a green color, and the third color is a blue color.

According to a second aspect of the present disclosure, an OLED display device is provided. The OLED display device includes: a plurality of first sub pixels displaying a first color; a plurality of second sub-pixels displaying a second color; and a plurality of third sub-pixels displaying a third color; wherein areas of the third sub-pixels are greater than areas of the first sub-pixels, and are greater than areas of the second sub-pixels; and wherein: the first sub-pixels and the second sub-pixels are alternately arranged in first columns; the third sub-pixels are arranged in second columns which are adjacent to the first columns; distances between a sub-pixel and another two sub-pixels which are adjacent to the sub-pixel in a second column are a first distance and a third distance, respectively; the first distance is smaller than the third distance and a distance between adjacent sub-pixels in the first columns.

In another exemplary embodiment of the present disclosure, the third distance is greater than a total of a distance between a first sub-pixel and a second sub-pixel which are adjacent to each other, a length of a first sub-pixel and a length of a second sub-pixel.

In another exemplary embodiment of the present disclosure, the first sub-pixels are arranged in first rows, and the second sub-pixels are arranged in second rows which are adjacent to the first rows.

In another exemplary embodiment of the present disclosure, the third sub-pixels have a length greater than a distance between a first sub-pixel and a second sub pixel which are adjacent to each other.

In another exemplary embodiment of the present disclosure, each of the third sub-pixels only overlaps in a raw direction with one row of the sub-pixels in the first columns.

In another exemplary embodiment of the present disclosure, the areas of the first sub-pixels are greater than the areas of the second sub-pixels.

In another exemplary embodiment of the present disclosure, distances between adjacent fist sub-pixels and second sub-pixels are the same; a distance between a first sub-pixel and a second sub-pixel which are adjacent to each other is equal to a distance between a first sub-pixel and a third sub-pixel which are adjacent to each other,

In another exemplary embodiment of the present disclosure, pixel electrodes of two adjacent third sub-pixels, a distance between which is the first distance, are covered by the same light emitting layer.

In another exemplary embodiment of the present disclosure, the first color is a red color, the second color is a green color, and the third color is a blue color.

According to a third aspect of the present disclosure, an OLED display device is provided. The OLED display device includes: a plurality of first sub-pixels displaying a first color; a plurality of second sub-pixels displaying a second color; and a plurality of third sub-pixels displaying a third color; wherein areas of effective display regions of the third sub-pixels are greater than areas of effective display regions of the first sub-pixels; and wherein: the first sub-pixels and the second sub-pixels are alternately arranged in first columns; the third sub-pixels are arranged in second columns which are adjacent to the first columns; a distance between effective display regions of two third sub-pixels which are immediately adjacent to each other in a second column is a first distance, a distance between effective display regions of a first sub-pixel and a second sub-pixel which are alternately arranged in a first column is a second distance, and the first distance is smaller than the second distance.

In another exemplary embodiment of the present disclosure, an effective display region of each of the third sub-pixels only overlaps in a row direction with the effective display regions of one row of the sub-pixels in the first columns.

In another exemplary embodiment of the present disclosure, the effective display regions of the third sub-pixels have a length greater than a distance between effective display regions of a first sub-pixel and a second sub-pixel which are adjacent to each other.

In another exemplary embodiment of the present disclosure, the first sub-pixels are arranged in first rows, and the second sub-pixels are arranged in second rows which are adjacent to the first rows.

In an exemplary embodiment of the present disclosure, the areas of the effective display regions of the first sub-pixels are greater than the areas of the effective display regions of the second sub-pixels.

In another exemplary embodiment of the present disclosure, pixel electrodes of two adjacent third sub-pixels, a distance between the effective display regions of which is the first distance, are covered by the same light emitting layer.

In another exemplary embodiment of the present disclosure, the first color is a red color, the second color is a green color, and the third color is a blue color.

According to a fourth aspect of the present disclosure, an OLED display device is provided. The OLED display device includes: a plurality of first sub-pixels displaying a first color; a plurality of second sub-pixels displaying a second color; and a plurality of third sub-pixels displaying a third color; wherein areas of effective display regions of the third sub-pixels are greater than areas of effective display regions of the first sub-pixels; arid wherein: the first sub-pixels and the second sub-pixels are alternately arranged in first columns; the third sub-pixels are arranged in second columns which are adjacent to the first columns; distances between effective display regions of a sub-pixel and another two sub-pixels which are adjacent to the sub-pixel in the second columns are a first distance and a third distance, respectively; the first distance is smaller than the third distance and a distance between effective display regions of adjacent sub-pixels in the first columns.

In another exemplary embodiment of the present disclosure, the third distance is greater than a total of a distance between effective display regions of a first sub-pixel and a second sub-pixel which are adjacent to each other, a length of an effective display region of a first sub-pixel and a length of an effective display region of a second sub-pixel.

In another exemplary embodiment of the present disclosure, the first sub-pixels are arranged in first rows, and the second sub-pixels are arranged in second rows which are adjacent to the first rows.

In another exemplary embodiment of the present disclosure, the effective display regions of the third sub-pixels have a length greater than a distance between effective display regions of a first sub-pixel and a second sub-pixel which are adjacent to each other.

In another exemplary embodiment of the present disclosure, an effective display region of each of the third sub-pixels only overlaps in a row direction with the effective display regions of one row of the sub-pixels in the first columns.

In another exemplary embodiment of the present disclosure, the areas of the effective display regions of the first sub-pixels are greater than the areas of the effective display regions of the second sub-pixels.

In another exemplary embodiment of the present disclosure, distances between effective display regions of adjacent fist sub pixels and second sub-pixels are the same; a distance between effective display regions of a first sub-pixel and a second sub-pixel which are adjacent to each other is equal to a distance between effective display regions of a first sub-pixel and a third sub-pixel which are adjacent to each other.

In another exemplary embodiment of the present disclosure, pixel electrodes of two adjacent third sub-pixels, a distance between the effective display regions of which is the first distance, are covered by the same light emitting layer.

In an exemplary embodiment of the present disclosure, the first color is a red color, the second color is a green color, and the third color is a blue color.

For further understanding of the features and technical contents of the present disclosure, please refer to the following detailed description and accompanying drawings of the present disclosure. However, the detailed description and accompanying drawings herein are only for illustrations of the present disclosure, but not for imposing any limitations on the scope as claimed in the appended claims.

Other properties and advantages of the present invention will become apparent from the following detailed description and drawings.

### BRIEF DESCRIPTION OF THE DRAWINGS

The above and other features and advantages of the present disclosure will become more apparent from the detailed description of the exemplary embodiments with reference to accompanying drawings.

FIG. 1 shows a schematic diagram of a pixel layout of an OLED display device in related technologies;

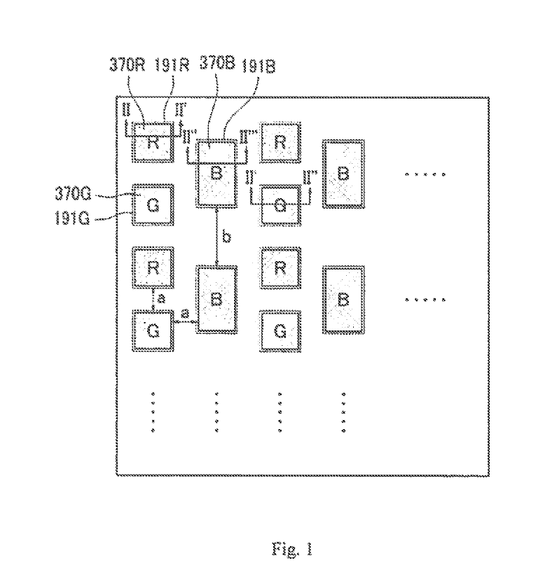

FIG. 2 shows a schematic diagram of a pixel layout of an OLED display device according an exemplary embodiment of the present disclosure; and

FIG. 3 shows a schematic diagram of a pixel layout of an OLED display device according another exemplary embodiment of the present disclosure.

### LISTING OF REFERENCE NUMBERS

191R, 1910, 191B pixel electrodes
370R, 3700, 370B emitting layers
11 first sub-pixel
12 second sub-pixel
13 third sub-pixel
20 non-effective display region
21 effective display region of the first sub-pixel
22 effective display region of the second sub-pixel
23 effective display region of the third sub-pixel
a, b, m, n, x, y distances

### DETAILED DESCRIPTION OF THE PRESENT INVENTION AND PREFERRED EMBODIMENTS

Now, exemplary implementations will be described more comprehensively with reference to the drawings. However, the exemplary implementations may be carried out in various manners, and shall not be interpreted as being limited to the implementations set forth herein; instead, these implementations merely make the present disclosure more comprehensive and complete and fully convey the conception of the exemplary implementations to one of ordinary skill in this art. In the drawings, thicknesses of regions and layers are exaggerated for the sake of clarity. Throughout the drawings similar reference signs indicate the some or similar structures, and their detailed description will be omitted.

In addition, the features, structures or characteristics described herein may be combined in one or more embodiments in any suitable manner. In the following description, many specific details are provided to facilitate sufficient understanding of the embodiments of the present disclosure. However, one of ordinary skill in the art will appreciate that the technical solutions in the present disclosure may be practiced without one or more of the specific details, or other methods, elements, materials and so on may be employed. In other conditions, well-known structures, materials or operations are not shown or described in detail to avoid confusion of respective aspects of the present disclosure.

### Example 1

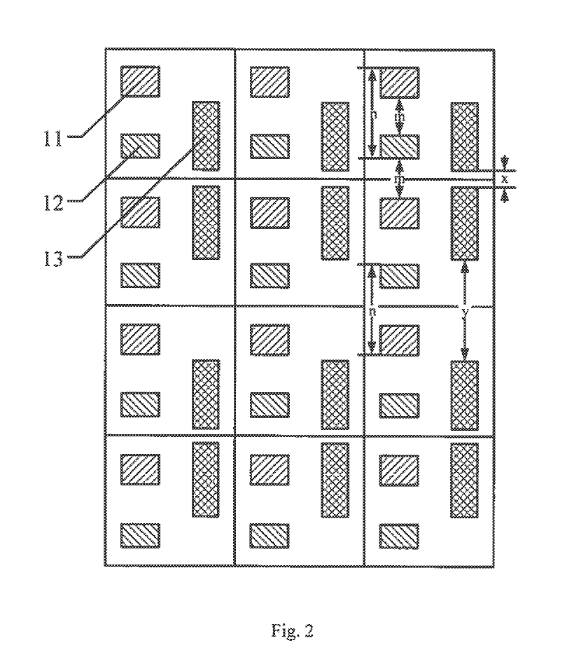

The exemplary embodiment provides an OLED display device. As shown in FIG. 2, the OLED display device includes first sub-pixels 11, second sub-pixels 12 and third sub pixels 11 The first sub-pixels 11 are configured to display a first color, for example, a red color; the second sub-pixels 12 are configured to display a second color, for example, a green color; the third sub-pixels 13 are configured to display a third color, for example, a blue color. Thus, pixel units constituted by the first sub-pixels 11, the second sub-pixels 12 and the third sub-pixels 13 may be used to display full colors.

In the exemplary embodiment, the first sub-pixels 11 and the second sub-pixel 12 are alternately arranged in first columns; the third sub-pixels 13 are arranged in second columns which are adjacent to the first columns. Specifically, the first columns are odd columns (the first column, the third column, the fifth column, . . . ), and accordingly, the second columns are even columns (the second column, the fourth column, the sixth column, . . . ); alternatively, the first columns are even columns, and accordingly the second columns are odd columns, and the present disclosure does not impose special limitations on this. In the present disclosure, every two third sub-pixels 13 constitute a unit, and the two third sub-pixels 13 are close to each other; in the present disclosure, the two third sub-pixels 13 close to each other in one unit are referred to as two third sub-pixels 13 which are immediately adjacent to each other; if two third sub-pixels 13 are merely adjacent but are not close to each other, they are not the “immediately adjacent” sub-pixels as defined in the present disclosure. A distance between two third sub-pixels 13 which are immediately adjacent to each other is a first distance x, and a distance between a first sub-pixel 11 and a second sub-pixel 12 which are alternately arranged in a first column is a second distance m, and the first distance x is smaller than the second distance m. The above layout of sub-pixels is helpful to some extent for resulting in another virtual pixel between respective pixel units, and thereby resolution of display images is enhanced visually.

As shown in FIG. 2, in the second column, a distance between a third sub-pixel 13 and another third sub-pixel 13 which is adjacent but not immediately adjacent to the third sub-pixel 13 is a third distance y; the first distance x is smaller than the third distance y. In an exemplary embodiment of the present disclosure, the third distance y is greater than as total of the distance m between a first sub-pixel 11 and a second sub-pixel 12 which are adjacent to each other, a length of the first sub-pixel 11 and a length of the second sub-pixel 12, i.e., the third distance y is greater than a distance n as shown in FIG. 2. It shall be noted that, a length of a sub-pixel when mentioned in the present disclosure refers to a length along a column direction of this sub-pixel.

Further, in an exemplary embodiment, a length of a third sub-pixel 13 is greater than the distance between a first sub-pixel 11 and a second sub-pixel 12 which are adjacent to each other, and each of the third sub-pixels 13 only overlaps in a row direction with one row of the first sub-pixels 11 or one row of the second sub-pixels 12. As shown in FIG. 2, the first sub-pixels 11 are arranged in first rows (odd rows in the exemplary embodiment); the second sub-pixels 12 are arranged in second rows (even rows in the exemplary embodiment) which are adjacent to the first rows. The first sub-pixels 1 in the first row do not overlap with the third sub-pixels 13 in the row direction, the second sub-pixels 12 in the second row overlap with the third sub-pixels 13 in the row direction, the first sub-pixels 11 ion the third row overlap with the third sub-pixels 13 in the row direction, the second sub-pixels 12 in the fourth row do not overlap with the third sub-pixels 13 in the row direction, and the first sub-pixels 11 in the fifth row do not overlap with the third sub-pixels 13 in the row direction, and the like.

In order to further reduce the influence of shade effects to increase aperture opening ratio of the OLED display device, pixel electrodes of two third sub-pixels 13, a distance between which is the first distance x, are covered by the same light emitting layer, i.e., the two third sub-pixels 13 which are close to each other are covered by the same light emitting layer. Thus, the opening of the mask may be increased and thereby the influence of the shade effects may be reduced.

In addition, each sub-pixel in the OLED display device includes an organic light emitting diode and corresponding driving circuits. Organic light emitting materials in the organic light emitting diode have a property that the materials will be automatically heated after start-up of the diode, and thus have a relatively short lifetime. Generally, green organic light emitting materials have the longest lifetime of more than 40,000 hours, the red organic light emitting materials have a lifetime slightly shorter than that of the green organic light emitting materials, and the blue organic light emitting materials have a faster thermalization and thereby have the shortest lifetime of about 10,000 to 15,000 hours, which is about one-third of the lifetime of the green organic light emitting materials. Thus, the lifetime of the blue sub-pixels limits the lifetime of the display panel to some extent. In view of this, in the present embodiment, the areas of the blue sub-pixels are greater than the areas of the red sub-pixels and the areas of the green sub-pixels; further, the areas of the red sub-pixels are greater than the areas of the green sub-pixels. Thus, by increasing the areas of the sub-pixels whose lifetimes are shorter so as to lengthen the lifetimes of the corresponding sub-pixels, the lifetime of the display panel may be lengthened accordingly.

### Example 2

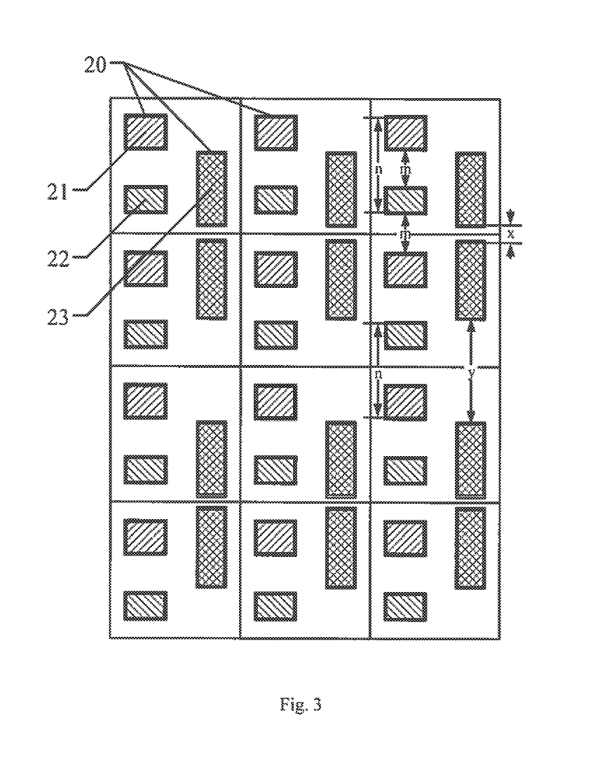

This embodiment provides an OLEO display device. As shown in FIG. 3, the OLED display device includes first sub-pixels, second sub-pixels and third sub-pixels. The first sub-pixels are configured to display a first color, for example, a red color; the second sub-pixels are configured to display a second color, for example, a green color; the third sub-pixels are configured to display a third color, for example, a blue color. Thus, pixel units constituted by the first sub-pixels, the second sub-pixels and the third sub-pixels may be used to display full colors. Among the areas of the first sub-pixels, the second sub-pixels and the third sub-pixels, in addition to some part for effective displaying, some other part is not used for displaying due to reasons such as arrangement of metal wires and so on, which is the non-effective display region 20 as shown in FIG. 3.

In the exemplary embodiment, the first sub-pixels and the second sub-pixel are alternately arranged in first columns; the third sub-pixels are arranged in second columns which are adjacent to the first columns. Specifically, the first columns are odd columns (the first column, the third column, the fifth column, . . . ), and accordingly, the second columns are even columns (the second column, the fourth column, the sixth column, . . . ); alternatively, the first columns are even columns, and accordingly the second columns are odd columns, and the present disclosure does not impose special limitations on this. One of the main distinctions of the present disclosure from the related technologies resides in: in the present disclosure, every two third sub-pixels constitute a unit, and the effective display regions 23 of the two third sub-pixels are close to each other; in the present disclosure, the two third sub-pixels 13 close to each other in one unit are referred to as two third sub-pixels 13 which are immediately adjacent to each other; if two third sub-pixels 13 are merely adjacent but are riot close to each other, they are not the “immediately adjacent” sub-pixels as defined in the present disclosure distance between the effective display regions 23 of two third sub-pixels 13 which are immediately adjacent to each other is a first distance x, and a distance between an effective display region 21 of a first sub-pixel 11 and an effective display region 72 of a second sub-pixel 12 which are alternately arranged in a first column is a second distance m, and the first distance x is smaller than the second distance m. The above layout of sub-pixels is helpful to some extent for resulting in another virtual pixel between respective pixel units, and thereby resolution of display images is enhanced visually.

As shown in FIG. 3, in a second column, a distance between an effective display region 23 of a third sub-pixel and an effective display region 23 of another third sub-pixel which is adjacent but not immediately adjacent to the third sub-pixel is a third distance y; the first distance x is smaller than the third distance y, and meanwhile the first distance x is smaller than the distance m between the effective display region 21 of a first sub-pixel and the effective display region 22 of a second sub-pixel which are adjacent to each other in a first column.

In an exemplary embodiment of the present disclosure, the third distance y is greater than a total of the distance m between an effective display region 21 of a first sub-pixel and an effective display region 22 of a second sub-pixel which are adjacent to each other, a length of the effective display region 21 of the first sub-pixel and a length of the effective display region 22 of the second sub-pixel, i.e., the third distance y is greater than a distance n as shown in FIG. 3. It shall be noted that, a length of an effective display region of a sub-pixel when mentioned in the present disclosure refers to a length along a column direction of the effective display region of this sub-pixel.

Further, in another exemplary embodiment, a length of an effective display region 23 of a third sub-pixel is greater than the distance between an effective display region 21 of a first sub-pixel and an effective display region 22 of a second sub-pixel which are adjacent to each other, and each of the effective display region 23 of the third sub-pixels only overlaps in a row direction with one row of the effective display region 21 of the first sub-pixels or one row of the effective display region 22 of the second sub-pixels. As shown in FIG. 3, the first sub-pixels are arranged in first rows (odd rows in the exemplary embodiment); the second sash-pixels are arranged in second rows (even rows in the exemplary embodiment) which are adjacent to the first rows. The effective display regions 21 of the first sub-pixels in the first row do not overlap with the effective display regions 23 of the third sub-pixels in the row direction, the effective display region 22 of the second sub-pixels in the second row overlap with the effective display region 23 of the third sub-pixels in the row direction, the effective display regions 21 of the first sub-pixels in the third row overlap with the effective display regions 23 of the third sub-pixels in the row direction, the effective display regions 22 of the second sub-pixels in the fourth row do not overlap with the effective display regions 23 of the third sub-pixels in the row direction, and the effective display regions 21 of the first sub-pixels in the fifth row do not overlap with the effective display regions 23 of the third sub-pixels in the row direction, and the like.

In order to further reduce the influence of shade effects to increase aperture opening ratio of the OLED display device, in the present exemplary embodiment, pixel electrodes of two third sub-pixels, a distance between the effective display regions of which is the first distance x, are covered by the same light emitting layer, i.e., the two third sub-pixels which are close to each other are covered by the same light emitting layer. Thus, the opening of the mask may be increased and thereby the influence of the shade effects may be reduced.

In addition, each sub-pixel in the OLED display device includes an organic light emitting diode and corresponding driving circuits. Organic light emitting materials in the organic light emitting diode have a property that the materials will be automatically heated after start-up of the diode, and thus have a relatively short lifetime. Generally, green organic light emitting materials have the longest lifetime of more than 40,000 hours, the red organic light emitting materials have a lifetime slightly shorter than that of the green organic light emitting materials, and the blue organic light emitting materials have a faster thermalization and thereby have the shortest lifetime of about 10,000 to 15,000 hours, which is about one-third of the lifetime of the green organic light emitting materials. Thus, the lifetime of the blue sub-pixels limits the lifetime of the display panel to some extent. In view of this, in the present embodiment, the areas of the effective display regions of the blue sub-pixels are greater than the areas of the effective display regions of the red stab-pixels and the areas of the effective display regions of the green sub-pixels; further; the areas of the effective display regions of the red sub-pixels are greater than the areas of the effective display regions of the green stab-pixels. Thus, by increasing the areas of the effective display regions of the sub-pixels whose lifetimes are shorter so as to lengthen the lifetimes of the corresponding sub-pixels, the lifetime of the display panel may be lengthened accordingly.

The present disclosure is described with reference to related embodiments, however, the above embodiments are just examples for implementation of the present disclosure. It shall be noted that, the disclosed embodiments do not limit the scope of the present disclosure, instead, modifications and variations without departing from the spirit and scope of the present disclosure fall within the protection scope of the present disclosure.

What is claimed is:

1. An Organic Light Emitting Diode (OLED) display device, comprising:
a plurality of first sub-pixels displaying a first color;
a plurality of second sub-pixels displaying a second color; and
a plurality of third sub-pixels displaying a third color;
wherein areas of the third sub-pixels are greater than areas of the first sub-pixels, and are greater than areas of the second sub-pixels; and
wherein:
the first sub-pixels and the second sub-pixels are alternately arranged in first columns;
the third sub-pixels are arranged in second columns which are adjacent to the first columns; and
each of the third sub-pixels only overlaps in a row direction with one row of the sub-pixels in the first columns.

2. The OLED display device according to claim 1, wherein the third sub-pixel has a length greater than a distance between a first sub-pixel and a second sub-pixel which are adjacent to each other.

3. The OLED display device according to claim 2, wherein the first sub-pixels are arranged in first rows, and the second sub-pixels are arranged in second rows which are adjacent to the first rows.

4. The OLED display device according to claim 1, wherein the areas of the first sub-pixels are greater than the areas of the second sub-pixels.

5. The OLED display device according to claim 4, wherein pixel electrodes of two adjacent third sub-pixels, a distance between which is the first distance, are covered by the same light emitting layer.

6. The OLED display device according to claim 4, wherein the first color is a red color, the second color is a green color, and the third color is a blue color.

7. An Organic Light Emitting Diode (PLED) display device, comprising:
a plurality of first sub-pixels displaying a first color;
a plurality of second sub-pixels displaying a second color; and
a plurality of third sub-pixels displaying a third color;
wherein areas of the third sub-pixels are greater than areas of the first sub-pixels, and are greater than areas of the second sub-pixels; and
wherein:
the first sub-pixels and the second sub-pixels are alternately arranged in first columns;
the third sub-pixels are arranged in second columns which are adjacent to the first columns; and
distances between a sub-pixel and another two sub-pixels which are adjacent to the sub-pixel in a second column are a first distance and a third distance, respectively; the first distance is smaller than the third distance and a distance between adjacent sub-pixels in the first columns.

8. The OLED display device according to claim 7, wherein the third distance is greater than a total of a distance between a first sub-pixel and a second sub-pixel which are adjacent to each other, a length of a first sub-pixel and a length of a second sub-pixel.

9. The OLED display device according to claim 8, wherein each of the third sub-pixels only overlaps in a row direction with one row of the sub-pixels in the first columns.

10. The OLED display device according to claim 8, wherein the third sub-pixel has a length greater than a distance between a first sub-pixel and a second sub-pixel which are adjacent to each other.

11. The OLED display device according to claim 10, wherein the first sub-pixels are arranged in first rows, and the second sub-pixels are arranged in second rows which are adjacent to the first rows.

12. The OLED display device according to claim 7, wherein the areas of the first sub-pixels are greater than the areas of the second sub-pixels.

13. The OLED display device according to claim 12, wherein pixel electrodes of two adjacent third sub-pixels, a distance between which is the first distance, are covered by the same light emitting layer.

14. The OLED display device according to claim 12, wherein the first color is a red color, the second color is a green color, and the third color is a blue color.

15. An Organic Light Emitting Diode (OLED) display device, comprising:
a plurality of first sub-pixels displaying a first color;
a plurality of second sub-pixels displaying a second color; and
a plurality of third sub-pixels displaying a third color;
wherein areas of effective display regions of the third sub-pixels are greater than areas of effective display regions of the first sub pixels; and
wherein:
the first stab-pixels and the second sub-pixels are alternately arranged in first columns;
the third stab-pixels are arranged in second columns which are adjacent to the first columns; and
an effective display region of each of the third sub-pixels only overlaps in a row direction with the effective display regions of one row of the sub-pixels in the first columns.

16. The OLED display device according to claim 15, wherein the effective display region of the third sub-pixel has a length greater than a distance between effective display regions of a first sub-pixel and a second sub-pixel which are adjacent to each other.

17. The OLED display device according to claim 16, wherein the first sub-pixels are arranged in first rows, and the second sub-pixels are arranged in second rows which are adjacent to the first rows.

18. The OLED display device according to claim 15, wherein the areas of the effective display regions of the first sub-pixels are greater than the areas of the effective display regions of the second sub-pixels.

19. The OLED display device according to claim 18, wherein pixel electrodes of two adjacent third sub-pixels, a distance between the effective display regions of which is the first distance, are covered by the same light emitting layer.

20. The OLED display device according to claim 18, wherein the first color is a red color, the second color is a green color, and the third color is a blue color.
